(19) United States
(12) Patent Application Publication
(10) Pub. No.: US 2005/0112302 A1
(43) Pub. Date: May 26, 2005

(54) Inkjet recording element and method of use

(76) Inventors: Thomas M. Laney, Spencerport, NY (US); Peter T. Aylward, Hilton, NY (US); Sandra J. Dagan, Churchville, NY (US); Bruce C. Campbell, Webster, NY (US); Kenneth W. Best JR., Hilton, NY (US)

Correspondence Address: Paul A. Leipold;Patent Legal Staff, Eastman Kodak Company, 343 State Street, Rochester, NY, 14650-2201, US

(21) Appl. No.: 10/722,886

(22) Filed: Nov. 26, 2003

(51) Int. Cl. B41M 5/00

(52) U.S. Cl. 428/32.31

(57) ABSTRACT

An inkjet recording element comprises a permeable microvoided polylactic-acid-containing layer having interconnecting voids. The invention is also directed to method of using such recording elements in an inkjet printing process and to sheets useful for making such inkjet recording elements and other media.

### CROSS-REFERENCE TO RELATED APPLICATIONS

The present application is related to U.S. application Ser. NO. (Docket 87430), filed Nov. 26, 2003, by Thomas M. Laney et al., and titled, “POLYLACTIC-ACID-BASED SHEET MATERIAL AND METHOD OF MAKING.”

### FIELD OF THE INVENTION

This invention relates to an inkjet recording element. More particularly, this invention relates to an inkjet recording element containing a porous inkjet receiver substrate with an optional porous inkjet receiving top layer.

### BACKGROUND OF THE INVENTION

In a typical inkjet recording or printing system, ink droplets are ejected from a nozzle at high speed towards a recording element or medium to produce an image on the medium. The ink droplets, or recording liquid, generally comprise a recording agent, such as a dye or pigment, and a large amount of solvent. The solvent, or carrier liquid, typically is made up of water, an organic material such as a monohydric alcohol, a polyhydric alcohol, or mixtures thereof.

An inkjet recording element typically comprises a support having on at least one surface thereof an ink-receiving or image-forming layer, and includes those intended for reflection viewing, which have an opaque support, and those intended for viewing by transmitted light, which have a transparent support.

While a wide variety of different types of image-recording elements for use with inkjet devices have been proposed heretofore, there are many unsolved problems in the art and many deficiencies in the known products which have limited their commercial usefulness.

It is well known that in order to achieve and maintain photographic-quality images on such an image-recording element, an inkjet recording element must be readily wetted so there is no puddling, i.e., coalescence of adjacent ink dots, which leads to non-uniform density; exhibit no image bleeding; exhibit the ability to absorb high concentrations of ink and dry quickly to avoid elements blocking together when stacked against subsequent prints or other surfaces; exhibit no discontinuities or defects due to interactions between the support and/or layer(s), such as cracking, repellencies, comb lines and the like; not allow unabsorbed dyes to aggregate at the free surface causing dye crystallization, which results in bloom or bronzing effects in the imaged areas; and exhibit an optimized image fastness to avoid fade from contact with water or radiation by daylight, tungsten light, or fluorescent light.

An inkjet recording element that simultaneously provides an almost instantaneous ink dry time and good image quality is desirable. However, given the wide range of ink compositions and ink volumes that a recording element needs to accommodate, these requirements of inkjet recording media are difficult to achieve simultaneously.

Inkjet recording elements are known that employ porous or non-porous single layer or multilayer coatings that act as suitable image receiving layers on one or both sides of a porous or non-porous support.

While a wide variety of different types of image-recording elements have been proposed heretofore, there are many unsolved problems in the art and many deficiencies in the known products which have severely limited their commercial usefulness. The requirements for an image-recording medium or element for inkjet recording are very demanding. For example, the recording element must be capable of absorbing or receiving large amounts of ink applied to the image-forming surface of the element as rapidly as possible in order to produce recorded images having good quality, including high optical density and low coalescence, and that can be handled without smearing shortly after printing. Large amounts of ink are often required for printing high quality, photographic-type images.

U.S. Pat. No. 6,379,780 to Laney et al. and U.S. Pat. No. 6,489,008, the disclosures of both of which is hereby incorporated by reference, discloses an inkjet recording element comprising an ink-permeable polyester substrate comprising a base polyester layer and an ink-permeable upper polyester layer, the upper polyester layer comprising a continuous polyester phase having an ink absorbency rate resulting in a dry time of less than about 10 seconds and a total absorbent capacity of at least about 14 cc/m², the substrate having thereon a porous image-receiving layer having interconnecting voids.

U.S. Pat. No. 5,443,780 to Matsumoto et al. discloses the use of an oriented film of polylactic acid and methods for producing the same. U.S. Pat. No. 5,405,887 to Morita et al. discloses breathable, hydrolysable, porous films made by a process comprising adding finely-powdered filler having an average particle size of 0.3 to 4 μm to a polylactic acid based resin. Such films are described as useful as a material for leakproof films of sanitary materials and packaging materials. Such materials are, therefore, not open-pore in nature.

It is an object of this invention to provide an inkjet recording element that has a fast ink dry time. It is another object of this invention to provide an inkjet recording element that provides a more robust material for a support.

### SUMMARY OF THE INVENTION

These and other objects are achieved in accordance with the invention which comprises an inkjet recording element comprising an ink-permeable microvoided layer comprising a continuous phase that is a polylactic-acid-based material.

In one embodiment, the microvoided layer can be used as a substrate having thereon a porous image-receiving layer.

The inkjet recording element of the invention provides a fast ink dry time, high gloss, high image density, and robust manufacture.

In one embodiment, the ink-permeable microvoided layer comprises a voided polylactic acid matrix using inorganic void initiators and a sequential stretching process. An advantage of the present invention is that interconnecting pores can be formed in the polylactic acid by employing relatively smaller size void initiators, including, for example, various inorganic particles such as titanium dioxide void initiators, which is an advantage compared to cross-linked microbeads.

The invention is also directed to an inkjet printing process, comprising the steps of:
A) providing an inkjet printer that is responsive to digital data signals;
B) loading the printer with an inkjet recording element comprising a support as described above;
C) loading the printer with an inkjet ink compositions; and
D) printing on the inkjet recording element using the inkjet ink in response to the digital data signals.

The term “ink-permeable” is defined by the Applicants to mean that either the ink recording agent and/or the carrier for the recording agent is capable of being efficiently being transported into the microvoided layer during use.

### DETAILED DESCRIPTION OF THE INVENTION

As noted above, the ink-recording element in the invention contains a microvoided layer comprising a polylactic acid-based material, also referred to herein as a polylactic-acid-containing layer. The polylactic-acid-based material used in the present invention comprises a polylactic-acid-based polymer including polylactic acid or and copolymers comprising compatible comonomers such as one or more hydroxycarboxylic acids. Exemplary hydroxycarboxylic acid includes glycolic acid, hydroxybutyric acid, hydroxyvaleric acid, hydroxypentanoic acid, hydroxycaproic acid and hydroxyheptanoic acid. The polylactic-acid-based material comprises 85 to 100% by weight of a polylactic-acid-based polymer (or PLA-based polymer). The PLA-based polymer preferably comprises from 85 to 100 mol % of a lactic-acid units (preferably derived from L-lactic acid) and optionally polymerization compatible other comonomers. Preferably, the PLA-based polymer comprises at least 85 mole percent, more preferably at least 90 mole percent, most preferably at least 95 mole percent of lactic-acid monomeric units whether derived from lactic acid monomers or lactide dimers.

Polylactic acid, also referred to as “PLA,” used in this invention includes polymers based essentially on single D- or L-isomers of lactic acid, or mixtures thereof. In a preferred embodiment, PLA is a thermoplastic polyester of 2-hydroxy lactate (lactic acid) or lactide units. The formula of the unit is: —[O—CH(CH₃)—CO]—. The alpha- carbon of the monomer is optically-active (L-configuration). The polylactic-acid-based polymer is typically selected from the group consisting of D-polylactic acid, L-polylactic acid, D,L-polylactic acid, meso-polylactic acid, and any combination of D-polylactic acid, L-polylactic acid, D,L-polylactic acid and meso-polylactic acid. In one embodiment, the polylactic acid-based material includes predominantly PLLA (poly-L-lactic acid). In one embodiment, the number average molecular weight is between about 15,000 and about 1,000,000.

The various physical and mechanical properties vary with change of racemic content, and as the racemic content increases, the PLA becomes amorphous, as described, for example, in U.S. Pat. No. 6,469,133, the contents of which are hereby incorporated by reference. In one embodiment, the polymeric material includes relatively low (less than about 5%) amounts of the racemic form of the polylactic acid. When the PLA content rises above about 5% of the racemic form, the amorphous nature of the racemic form may alter the physical and/or mechanical properties of the resulting material.

Additional polymers can be added to the polylactic-acid-based material so long as they are compatible with the polylactic-acid-based polymers. In one embodiment, compatibility is miscibility (defined as one polymer being able to blend with another polymer without a phase separation between the polymers) such that the polymer and the polylactic-acid-based polymer are miscible under conditions of use. Typically, polymers with some degree of polar character can be used. Suitable polymeric resins that are miscible with polylactic acid to some extent can include, for example, polyvinyl chloride, polyethylene glycol, polyglycolide, ethylene vinyl acetate, polycarbonate, polycaprolactone, polyhydroxyalkanoates (polyesters), polyolefins modified with polar groups such as maleic anhydride and others, ionomers, e.g. SURLYN® (DuPont Company), epoxidized natural rubber and other epoxidized polymers.

In one particular embodiment of the present invention, a polylactic acid comprises a mixture of at least 90%, preferably about 96% poly(L-lactic acid) and at least 15, preferably about 4% poly(D-lactic acid), which is preferable from the viewpoint processing durability.

To the polylactic-acid-based material, various kinds of known additives, for example, an oxidation inhibitor, or an antistatic agent may be added by a volume which does not destroy the advantages according to the present invention. As mentioned above, the polylactic-acid-containing layer can up to 15 weight percent of additional polymers or blends of other polyesters in the continuous phase. Optionally, chain extenders can be used for the polymerization, as will be understood by the skilled artisan. Chain extenders include, for example, higher alcohols such as lauryl alcohol and hydroxy acids such as lactic acid and glycolic acid.

The polylactic-acid-containing layer can comprise a film or sheet of one or more thermoplastic polylactic-acid-based polymers (including polymers comprising individual isomers or mixtures of isomers), which film has been biaxially stretched (that is, stretched in both the longitudinal and transverse directions) to create the microvoids therein around void initiating particles. Any suitable polylactic acid or polylactide can be used as long as it can be cast, spun, molded, or otherwise formed into a film or sheet, and can be biaxially oriented as noted above. Generally, the polylactic acids have a glass transition temperature of from about 55 to about 65° C. (preferably from about 58 to about 64° C.) as determined using a differential scanning calorimeter (DSC).

Suitable polylactic-based polymers can be prepared by polymerization of lactic acid or lactide and comprise at least 50% by weight of lactic acid residue repeating units (including lactide residue repeating units), or combinations thereof. These lactic acid and lactide polymers include homopolymers and copolymers such as random and/or block copolymers of lactic acid and/or lactide. The lactic acid residue repeating monomer units may be obtained from L-lactic acid, D-lactic acid, by first forming L-lactide, D-lactide or LD-lactide, preferably with L-lactic acid isomer levels up to 75%. Examples of commercially available polylactic acid polymers include a variety of polylactic acids that are available from Chronopol Inc. (Golden, Colo.), or polylactides sold under the tradename EcoPLA®. Further examples of suitable commercially available polylactic acid are Natureworks® from Cargill Dow, Lacea® from Mitsui Chemical, or L5000 from Biomer. When using polylactic acid, it may be desirable to have the polylactic acid in the semi-crystalline form.

Polylactic acids may be synthesized by conventionally known methods such as a direct dehydration condensation or lactic acid or a ring-opening polymerization of a cyclic dimer (lactide) of lactic acid in the presence of a catalyst. However, polylactic acid preparation is not limited to these processes. Copolymerization may also be carried out in the above processes by addition of a small amount of glycerol and other polyhydric alcohols, butanetetracarboxylic acid and other aliphatic polybasic acids, or polysaccharide and other polyhydric alcohols. Further, molecular weight of polylactic acid may be increased by addition of a chain extender such as diisocyanate. Compositions for polylactic-acid-based polymers are also disclosed in U.S. Pat. No. 5,405,887, hereby incorporated by reference.

At least one layer in the inkjet recording element of the present invention has a continuous polylactic-acid-containing phase. Dispersed within that continuous phase is a second phase comprised of interconnecting microvoids which can contain inorganic particles, typically as void initiators. The polylactic acid and microvoids can be provided and generated as described below. The size of the void initiating particles which initiate the voids upon stretching should have an average particle size of 5 nm to 15 to μm, usually 0.1 to 10.0, most usually 0.3 to 2.0, and desirably 0.5 to 1.5 μm. Average particle size is that as measured by a Sedigraph® 5100 Particle Size Analysis System (by PsS, Limited). Preferred void initiating particles are inorganic particles, including but not limited to, barium sulfate, calcium carbonate, zinc sulfide, titanium dioxide, silica, alumina, and mixtures thereof, etc. Barium sulfate, zinc sulfide, or titanium dioxide are especially preferred.

In one embodiment of the present invention, the microvoided layer is an uppermost ink-receiving layer. Alternatively, the microvoided layer is a support, or component thereof, for the inkjet recording element. Still alternatively, the microvoided layer can be located between a support and an ink-receiving layer, for example, used as a sump layer for the carrier fluid.

When used in the support, the microvoided layer can be part of a monolayer or multilayer support, in the latter case adjacent a second support layer. The second support layer can be, for example, voided or non-voided polylactic acid-containing layer adjacent to and integral with said microvoided layer. Alternatively, the second support layer can comprise paper or resin coated paper.

In a preferred embodiment, a support for the inkjet recording element comprises a substrate comprising at least one microvoided layer that comprises a continuous polylactic-acid-containing first phase and a second phase dispersed within the continuous polylactic-acid-containing first phase, the second phase comprised of microvoids containing inorganic particles.

In other embodiments, the support comprises at least one other support layer that is arranged adjacent the polylactic-acid-containing layer. This additional polymer layer(s) can be co-extruded with the polylactic acid-containing layer or adhered to it in a suitable manner. Any suitable film-forming polymer (or mixture thereof) can be used in the additional polymer layer(s). The polymer in adjacent layer can be any suitable material that provides a continuous film, including a polyester or polylactic acid.

In one embodiment of the present invention a second voided or unvoided polylactic-acid-containing layer is adjacent to said polylactic acid-containing microvoided layer. The two layers may be integrally formed using a co-extrusion or extrusion coating process. The polylactic acid of the second voided layer can be any of the polylactic acids described previously for the inorganic particle voided layer.

It is possible for the voids of this second voided layer or the microvoided layer to be formed by, instead of particles, by finely dispersing a polymer incompatible with the matrix polylactic-acid-based material and stretching the film uniaxially or biaxially. (It is also possible to have mixtures of particles and incompatible polymers.) When the film is stretched, a void is formed around each particle of the incompatible polymer. Since the formed fine voids operate to diffuse a light, the film is whitened and a higher reflectance can be obtained. The incompatible polymer is a polymer that does not dissolve into the polylactic acid. Examples of such an incompatible polymer include poly-3-methylbutene-1, poly- 4- methylpentene-1, polypropylene, polyvinyl-t-butane, 1,4-transpoly-2,3- dimethylbutadiene, polyvinylcyclohexane, polystyrene, polyfluorostyrene, cellulose acetate, cellulose propionate and polychlorotrifluoroethylene. Among these polymers, polyolefins such as polypropylene are suitable.

In still another embodiment of the invention, paper is laminated to the other side of the polylactic acid-containing layer which does not have thereon the image-receiving layer. In this embodiment, the polylactic-acid-containing layer may be thin, as the paper would provide sufficient stiffness.

In another embodiment of the invention, the substrate also contains a lower permeable layer adjacent to the polylactic acid-containing layer on the opposite side from the ink-permeable porous polyester layer.

The present invention does not require but permits the use or addition of various organic and inorganic materials such as pigments, anti-block agents, antistatic agents, plasticizers, dyes, stabilizers, nucleating agents, and other addenda known in the art to the reflective substrate. These materials may be incorporated into the polylactic acid phase or they may exist as separate dispersed phases and can be incorporated into the polylactic acid using known techniques.

The substrate used in this invention has rapid absorption of ink, as well as high absorbent capacity, which allows rapid printing and a short dry time. A short dry time is advantageous, as the prints are less likely to smudge and have higher image quality as the inks do not coalesce prior to drying.

The polylactic acid-containing microvoided layer, especially when used as a support has the look and feel of paper, which is desirable to the consumer, has a desirable surface look without pearlescence, presents a smooth desirable image, is weather resistant and resistant to curling under differing humidity conditions, and has high resistance to tearing and deformation.

The microvoided polylactic-acid-containing layer has levels of voiding, thickness, and smoothness adjusted to provide optimum ink absorbency, stiffness, and gloss properties. The microvoided polylactic-acid-containing layer contains voids to efficiently absorb the printed inks commonly applied to ink-jet imaging supports without the need of multiple processing steps and multiple coated layers. The polylactic acid-containing layer can also provide stiffness to the media and physical integrity to other layers. The thickness of the microvoided polylactic acid layer is 30 to 400 μm depending on the required stiffness of the recording element. However, the thickness of the microvoided polylactic-acid-containing layer is preferably adjusted to the total absorbent capacity of the ink-recording element. A thickness of at least 28.0 μm is needed to achieve a total absorbency of 14 cc/m².

The fact that the ink-permeable microvoided polylactic-acid-containing layer contains voids that are interconnected or open-celled in structure enhances the ink absorption rate by enabling capillary action to occur.

Preferably, the ink-permeable microvoided polylactic-acid-containing layer has an absorbing rate resulting in a dry time of less than 10 seconds. Dry time may be measured by printing a color line on the side of the microvoided layer with an HP 722 ink-jet printer using a standard HP dye-based ink cartridge (HP # C1823A) at a laydown of approximately 14 cc/m².

Dry time is measured by superposing a piece of bond paper on top of the printed line pattern immediately after printing and pressing the papers together with a roller press. If a particular printed line transfers to the surface of the bond paper, its transferred length L could be used for estimating the dry time t_{D} using a known linear transport speed S for the printer based on the formula

$${t}_{D} = \frac{L}{S}$$

In a preferred embodiment, the ink absorbency rate results in a measured dry time of less than about one second.

In the preferred embodiment, the microvoided layer should have a total absorbant capability of at least 14.0 cc/m², i.e., should be such as to enable at least 14.0 cc of ink to be absorbed per 1 m². This is a calculate number, based on the thickness of the microvoided polylactic acid layer. The actual thickness can be determined by using the formula t=14.0/v where v is the void volume fraction defined as the ratio of voided thickness minus unvoided thickness to the voided thickness. The actual thickness, if an extruded monolayer can be easily measured. If a co-extruded layer, photomicroscopy of a cross-section can be used to determine the actual thickness. The unvoided thickness is defined as the thickness that would be expected had no voiding occurred, for example, the cast thickness divided by the stretch ratio in the machine direction and the stretch ratio in the cross direction.

Voids in the ink-permeable microvoided polylactic-acid-containing layer may be obtained by using void initiators in the required amount during its fabrication. Such void initiators may be inorganic fillers, as described above, or polymerizable organic materials. The particle size of void initiators is preferably in the range of from about 0.1 to about 50 μm, more preferably from about 0.5 to about 5 μm, for best formation of an ink porous but smooth surface. The void initiators may be employed in an amount of 30-50% by volume in the feed stock for the ink-permeable microvoided polylactic-acid-containing layer prior to extrusion and microvoiding.

Although organic microbeads as well as inorganics can be used as void initiators, inorganics have the significant advantage, as shown in Table 1 below, that the PLA allows for inorganics to be used in sequential stretch process where polyester does not. Typical polymeric organic materials for the microbeads include polystyrenes, polyamides, fluoro polymers, poly(methyl methacrylate), poly(butyl acrylate), polycarbonates, or polyolefins.

The polylactic acid-containing layer used in this invention may be made on readily available film formation machines such as employed with conventional polyester materials. The substrate is preferably prepared in one step with the microvoided polylactic acid layer can be monoextruded or coextruded and stretched. The one step formation process leads to low manufacturing cost.

The process for adding the inorganic particle or other void initiator to the polylactic-acid-based matrix is not particularly restricted. The particles can be added in an extrusion process utilizing a twin-screw extruder.

A process for producing a preferred embodiment of the film according to the present invention will now be explained. However, the process is not particularly restricted to the following one.

Inorganic particles can be mixed into polylactic acid in a twin screw extruder at a temperature of 170-220° C. This mixture is extruded through a strand die, cooled in a water bath, and pelletized. The pellets are then dried at 50° C. and fed into an extruder “A”.

The molten sheet delivered from the die is cooled and solidified on a drum having a temperature of 40-60° C. while applying either an electrostatic charge or a vacuum. The sheet is stretched in the longitudinal direction at a draw ratio of 2-5 times during passage through a heating chamber at a temperature of 70-90° C. Thereafter, the film is introduced into a tenter while the edges of the film are clamped by clips. In the tenter, the film is stretched in the transverse direction in a heated atmosphere having a temperature of 70-90° C. Although both the draw ratios in the longitudinal and transverse directions are in the range of 2 to 5 times, the area ratio between the non-stretched sheet and the biaxially stretched film is preferably in the range of 9 to 20 times. If the area ratio is greater than 20 times, a breakage of the film is liable to occur. Thereafter, the film is uniformly and gradually cooled to a room temperature, and wound.

Inorganic particles are incorporated into the continuous polylactic acid phase as described below. These particles comprise from about 45 to about 75 weight % (preferably from about 55 to about 70 weight %) of the total microvoided layer.

The inorganic particles can be incorporated into the continuous polylactic-acid phase by various means. For example, they can be incorporated during polymerization of the lactic acid or lactide used to make the continuous first phase. Alternatively and preferably, they are incorporated by mixing them into pellets of polylactic acid and extruding the mixture to produce a melt stream that is cooled into the desired sheet containing inorganic particles dispersed within the microvoids.

These inorganic particles are at least partially bordered by voids because they are embedded in the microvoids distributed throughout the continuous polylactic acid first phase. Thus, the microvoids containing the inorganic particles comprise a second phase dispersed within the continuous polylactic acid first phase. The microvoids generally occupy from about 40 to about 65% (by volume) of the microvoided layer.

The microvoids can be of any particular shape, that is circular, elliptical, convex, or any other shape reflecting the film orientation process and the shape and size of the inorganic particles. The size and ultimate physical properties of the microvoids depend upon the degree and balance of the orientation, temperature and rate of stretching, crystallization characteristics of the polylactic acid, the size and distribution of the inorganic particles, and other considerations that would be apparent to one skilled in the art. Generally, the microvoids are formed when the extruded sheet containing inorganic particles is biaxially stretched using conventional orientation techniques.

Thus, in one embodiment, the polylactic acid-containing layer used in the practice of this invention can be prepared by:
(a) blending inorganic particles into a desired polylactic-acid-based material as the continuous phase;
(b) forming a sheet of the polylactic-acid-based material containing inorganic particles, such as by extrusion; and
(c) stretching the sheet in one or transverse directions to form microvoids around the inorganic particles.

In a preferred embodiment, the permeable microvoided layer is extruded as a monolayer film. Preferably, the permeable microvoided layer is stretched at a temperature of under 90° C., preferably at a temperature of 74 to 84° C., more preferably about 78° C.

As noted above, the porous image-receiving layer that could be utilized in the invention contains interconnecting voids. These voids provide a pathway for an ink to penetrate appreciably into the substrate, thus allowing the substrate to contribute to the dry time. A non-porous image-receiving layer or a porous image-receiving layer that contains closed cells will not allow the substrate to contribute to the dry time.

The top surface of the polylactic acid-containing layer can serve as an ink-receiving layer. When the polylactic acid-containing layer is used, however, as a substrate below an optional porous image-receiving layer, interconnecting voids are preferably also present in the image-receiving layer. It is also preferred that the voids in the ink-receiving layer are open to (connect with) and preferably have a void size similar to the voids in the polylactic acid-containing layer for optimal interlayer absorption.

The interconnecting voids in the optional porous image-receiving layer may be obtained by a variety of methods. For example, the layer may contain particles dispersed in a polymeric binder. The particles may be organic such as poly(methyl methacrylate), polystyrene, poly(butyl acrylate), etc. or inorganic such as silica, alumina, zirconia, titania, calcium carbonate or barium sulfate. In a preferred embodiment of the invention, the particles have a particle size of from about 5 nm to about 15 μm.

The polymeric binder Which may be used in the image-recording layer of the invention, can be, for example, a hydrophilic polymer such as poly(vinyl alcohol), polyvinyl acetate, polyvinyl pyrrolidone, gelatin, poly(2-ethyl-2-oxazoline), poly(2-methyl-2-oxazoline), poly(acrylamide), chitosan, poly(ethylene oxide), methyl cellulose, ethyl cellulose, hydroxyethyl cellulose, hydroxypropyl cellulose, etc. Other binders can also be used such as hydrophobic materials such as poly(styrene-co-butadiene), a polyurethane latex, a polyester latex, poly(n-butyl acrylate), poly(n-butyl methacrylate), poly(2-ethylhexyl acryl ate), a copolymer of n-butylacrylate and ethyl acryl ate, a copolymer of vinylacetate and n-butylacrylate, etc.

In another preferred embodiment of the invention, the volume ratio of the particles to the polymeric binder is from about 1:1 to about 15:1.

Other additives may also be included in the image-receiving layer such as pH-modifiers like nitric acid, cross-linkers, rheology modifiers, surfactants, UV-absorbers, biocides, lubricants, dyes, dye-fixing agents or mordants, optical brighteners etc.

An image-receiving layer may be applied to one or both substrate surfaces through conventional pre-metered or post-metered coating methods such as blade, air knife, rod, roll coating, etc. The choice of coating process would be determined from the economics of the operation and in turn, would determine the formulation specifications such as coating solids, coating viscosity, and coating speed.

The image-receiving layer thickness may range from about 1 to about 60 μm, preferably from about 5 to about 40 μm.

After coating, the inkjet recording element may be subject to calendering or supercalendering to enhance surface smoothness.

Inkjet inks used to image the recording elements of the present invention are well-known in the art. The ink compositions used in inkjet printing typically are liquid compositions comprising a solvent or carrier liquid, dyes or pigments, humectants, organic solvents, detergents, thickeners, preservatives, and the like. The solvent or carrier liquid can be solely water or can be water mixed with other water-miscible solvents such as polyhydric alcohols. Inks in which organic materials such as polyhydric alcohols are the predominant carrier or solvent liquid may also be used. Particularly useful are mixed solvents of water and polyhydric alcohols. The dyes used in such compositions are typically water-soluble direct or acid type dyes. Such liquid compositions have been described extensively in the prior art including, for example, U.S. Pat. Nos. 4,381,946; 4,239,543 and 4,781,758, the disclosures of which are hereby incorporated by reference.

Another aspect of the present invention is directed to a single-layer or multilayer sheet comprising a microvoided layer permeable to low surface tension liquids (less than 50 dynes/cm²), which microvoided layer comprises a continuous polylactic-acid-based phase and interconnecting microvoids, said microvoided layer having a total absorbent capacity of at least about 14 cc/m², wherein inorganic particles (as described above) having an average diameter in the range of 0.1 to 1.0 micrometers are used as microvoiding agents. It is especially advantageous for the average diameter of the particles to be in the range of 0.1 to 0.6 micrometers. Preferably, such single-layer and multiplayer sheets are extruded as a single layer or multi-layer, respectively. It is also advantageous for the extruded or co-extruded layers to be sequentially stretched, first in the machine direction and then in the transverse direction. Such a sheet is useful for making inkjet recording elements and other imaging elements.

The following examples further illustrate the invention.

### PREPARATIVE EXAMPLES

### Comparative 1 (Co-extruded)

A two-layered polyester cast film is prepared in the following manner. The materials used in the preparation are:
1) a poly(ethylene terephthalate) (PET) resin (IV=0.70 dl/g) for the base layer;
2) a compounded mix consisting of 58% by weight of an amorphous polyester resin, PETG 6763® resin (IV=0.73dl/g) (Eastman Chemical Company) and 42% by weight of cross-linked PMMA microbeads approximately 1.7 um in size for the layer to be voided.

The cross-linked PMMA microbeads were compounded with the PETG 6763® through mixing in a counter-rotating twin screw extruder attached to a pelletizing die. Then both resins were dried at 65° C. and fed by two plasticating screw extruders into a coextrusion die manifold to produce a two-layered melt stream (265° C.) which was rapidly quenched on a chill roll after issuing from the die. By regulating the throughputs of the extruders, it was possible to adjust the thickness ratio of the layers in the cast laminate sheet. In this case, the thickness ratio of the two layers was adjusted at 1:1 with the thickness of both cast layers being approximately 450 μm.

### Comparative 2 (Co-extruded)

A two-layered polyester cast film is prepared in the following manner. The materials used in the preparation are:
1) a poly(ethylene terephthalate) (PET) resin (IV=0.70 dl/g) for the base layer;
2) a compounded mix consisting of 31% by weight of an amorphous polyester resin, PETG 6763® resin (IV=0.73 dl/g) (Eastman Chemical Company) and 69% by weight of Barium Sulfate (Blanc Fixe Micro from Sachtleben) with a mean particle size of 0.8 μm for the layer to be voided.

The Barium Sulfate was compounded with the PETG 6763® through mixing in a counter-rotating twin screw extruder attached to a pelletizing die. Then both resins were dried at 65° C. and fed by two plasticating screw extruders into a coextrusion die manifold to produce a two-layered melt stream (265° C.) which was rapidly quenched on a chill roll after issuing from the die. By regulating the throughputs of the extruders, it was possible to adjust the thickness ratio of the layers in the cast laminate sheet. In this case, the thickness ratio of the two layers was adjusted at 1:1 with the thickness of both cast layers being approximately 450 μm.

### Comparative 3 (Co-extruded)

A two-layered polyester cast film is prepared in the following manner. The materials used in the preparation are: 1) a poly(ethylene terephthalate) (PET) resin (IV=0.70 dl/g) for the base layer; 2) a compounded mix consisting of 38% by weight of an amorphous polyester resin, PETG 6763® resin (IV=0.73 dl/g) (Eastman Chemical Company) and 62% by weight of Zinc Sulfide (Sachtolith HD-S from Sachtleben) with a mean particle size of 0.35 μm for the layer to be voided.

The Zinc Sulfide was compounded with the PETG 6763® through mixing in a counter-rotating twin screw extruder attached to a pelletizing die. Then both resins were dried at 65° C. and fed by two plasticating screw extruders into a coextrusion die manifold to produce a two-layered melt stream (265° C.) which was rapidly quenched on a chill roll after issuing from the die. By regulating the throughputs of the extruders, it was possible to adjust the thickness ratio of the layers in the cast laminate sheet. In this case, the thickness ratio of the two layers was adjusted at 1:1 with the thickness of both-cast layers being approximately 450 μm.

### Example 1 (Co-extruded)

A two-layered Poly Lactic Acid (PLA) cast film is prepared in the following manner. The materials used in the preparation are:
1) a PLA resin (NatureWorks 2002-D by Cargill-Dow) for the base layer; 2) a compounded mix consisting of 58% by weight of PLA resin (NatureWorks 2002-D by Cargill-Dow) and 42% by weight of cross-linked PMMA microbeads approximately 1.7 um in size for the layer to be voided.

The cross-linked PMMA microbeads were compounded with the PLA resin through mixing in a counter-rotating twin screw extruder attached to a pelletizing die. Then both resins were dried at 52° C. and fed by two plasticating screw extruders into a coektrusion die manifold to produce a two-layered melt stream (200° C. ) which was rapidly quenched on a chill roll after issuing from the die. By regulating the throughputs of the extruders, it was possible to adjust the thickness ratio of the layers in the cast laminate sheet. In this case, the thickness ratio of the two layers was adjusted at 1:1 with the thickness of both cast layers being approximately 450 μm.

### Example 2 (Co-extruded)

A two-layered Poly Lactic Acid (PLA) cast film is prepared in the following manner. The materials used in the preparation are:
1) a PLA resin (NatureWorks 2002-D by Cargill-Dow) for the base layer; 2) a compounded mix consisting of 35% by weight of PLA resin (NatureWorks 2002-D by Cargill-Dow) and 65% by weight of Barium Sulfate (Blanc Fixe Micro from Sachtleben) with a mean particle size of 0.8 μm for the layer to be voided.

The Barium Sulfate was compounded with the PLA resin through mixing in a counter-rotating twin screw extruder attached to a pelletizing die. Then both resins were dried at 52° C. and fed by two plasticating screw extruders into a coextrusion die manifold to produce a two-layered melt stream (200° C.) which was rapidly quenched on a chill roll after issuing from the die. By regulating the throughputs of the extruders, it was possible to adjust the thickness ratio of the layers in the cast laminate sheet. In this case, the thickness ratio of the two layers was adjusted at 1:1 with the thickness of both cast layers being approximately 450 μm.

### Example 3 (Co-extruded)

A two-layered Poly Lactic Acid (PLA) cast film is prepared in the following manner. The materials used in the preparation are: 1) a PLA resin (NatureWorks 2002-D by Cargill-Dow) for the base layer; 2) a compounded mix consisting of 32% by weight of PLA resin (NatureWorks 2002-D by Cargill-Dow) and 68% by weight of Zinc Sulfide (Sachtolith HD-S from Sachtleben) with a mean particle size of 0.35 μm for the layer to be voided.

The Zinc Sulfide was compounded with the PLA resin through mixing in a counter-rotating twin screw extruder attached to a pelletizing die. Then both resins were dried at 65° C. and fed by two plasticating screw extruders into a coextrusion die manifold to produce a two-layered melt stream (200° C.) which was rapidly quenched on a chill roll after issuing from the die. By regulating the throughputs of the extruders, it was possible to adjust the thickness ratio of the layers in the cast laminate sheet. In this case, the thickness ratio of the two layers was adjusted at 1:1 with the thickness of both cast layers being approximately 450 μm.

In order to determine the manufacturability of the cast sheet samples above into a co-extruded film with an impermeable base layer and a voided open cell absorbent top layer the following evaluation was carried out. Each of the cast films was oriented or stretched in both the machine and transverse directions at a stretch ratio of 3.3. This was done utilizing a laboratory orienter capable of stretching in both directions simultaneously (Simul-Stretch) and in the machine direction first followed by the transverse direction (Sequential-Stretch). Samples of each film were stretched in both modes at varying temperatures. The lowest temperature at which the sample would stretch without tearing was first determined. The drytime was measured on the voided layer of the film to verify that it was less than 1 sec. Then more samples of each film were stretched at increasing temperatures. This was continued until a temperature at which the drytime became greater than 5 seconds was determined. The difference in temperature in degrees ° C. between the lowest stretch temperature and the highest stretch temperature that drytime remained below 5 seconds is called the process range. If there was no temperature that the sample could be stretched at to give a drytime less than 1 sec the process range is 0. Where the drytime of the film was below 5 seconds, the void volume of the voided layer was also determined by measuring before and after stretch thicknesses using a photo-microscope of a cross section of the films. From this it was determined that the absorbent capacity of porous voided layers of each film was at least 14 cc/m2. Table 1 shows the process ranges determined for both stretching modes.

TABLE 1

| | | | PROCESS | PROCESS |
|---|---|---|---|---|
| | | | RANGE | RANGE |
| CO- | | MATRIX | SIMUL- | SEQUENTIAL- |
| EXTRUDED | VOID | POLY- | STRETCH | STRETCH |
| SAMPLE | INITIATOR | MER | ° C. | ° C. |
| Comparative | PMMA | PETG | 8 | 4 |
| 1 | Beads | | | |
| Comparative | BaSO4 | PETG | 2 | 0 |
| 2 | | | | |
| Comparative | ZnS | PETG | 0 | 0 |
| 3 | | | | |
| Example 1 | PMMA | PLA | 9 | 4 |
| | Beads | | | |
| Example 2 | BaSO4 | PLA | 10 | 4 |
| Example 3 | ZnS | PLA | 6 | 2 |

It can be seen from Table 1 that neither inorganic particle, Barium Sulfate (BaSO4) or Zinc Sulfide (ZnS) could produce a manufacturable open cell film in a sequential-stretch process when using PETG as the matrix polymer. Although there was a process range of 2° C. for BaSO₄ in a simul-stretch process this process has limited utility in practice as very few production scale machines have such capability. The ZnS had no process window even in a simul-stretch process. However, when using PLA as the matrix polymer both inorganic particles could produce a manufacturable open cell film in either a simil-stretch or sequential-stretch mode. This has utility both in that it allows for readily available (less costly) inorganic particles to be used as void initiators for open cell film and it allows for smaller particles (0.35 um for ZnS) to be used which enables smaller voids. Smaller voids have utility in many aspects as has been discussed previously.

The results for PLA/PMMA is slightly better than the PETG/PMMA in terms of a process window, and the PLA with inorganic particles (BaSO4 or ZnS) has a significantly bigger processing window than the PETG with inorganic particles. Another advantage of the inorganic particles is that smaller voids can be created.

### Comparative 4 (Single Layer)

A single-layer polyester cast film is prepared in the following manner:

The material used in the preparation was a compounded mix consisting of 58% by weight of an amorphous polyester resin, PETG 6763® resin (IV=0.73 dl/g) (Eastman Chemical Company) and 42% by weight of cross-linked PMMA microbeads approximately 1.7 um in size.

The cross-linked PMMA microbeads were compounded with the PETG 6763® through mixing in a counter-rotating twin screw extruder attached to a pelletizing die. The resin pellets were then was dried at 65° C. and fed by a plasticating screw extruder into an extrusion die manifold to produce a single layer melt stream (265° C.) which was rapidly quenched on a chill roll after issuing from the die. By regulating the throughput of the extruder, it was possible to adjust the thickness of the cast sheet to approximately 900 μm.

### Comparative 5 (Single Layer)

A single-layer polyester cast film is prepared in the following manner. The material used in the preparation was a compounded mix consisting of 31% by weight of an amorphous polyester resin, PETG 6763® resin (IV=0.73 dl/g) (Eastman Chemical Company) and 69% by weight of Barium Sulfate (Blanc Fixe Micro from Sachtleben) with a mean particle size of 0.8 μm.

The Barium Sulfate was compounded with the PETG 6763® through mixing in a counter-rotating twin screw extruder attached to a pelletizing die. The resin pellets were then was dried at 65° C. and fed by a plasticating screw extruder into an extrusion die manifold to produce a single layer melt stream (265° C.) which was rapidly quenched on a chill roll after issuing from the die. By regulating the throughput of the extruder, it was possible to adjust the thickness of the cast sheet to approximately 900 μm.

### Example 4 (Single Layer)

A single-layer polyester cast film is prepared in the following manner. The material used in the preparation was a compounded mix consisting of 58% by weight of PLA resin (NatureWorks 2002-D by Cargill-Dow) and 42% by weight of cross-linked PMMA microbeads approximately 1.7 um in size.

The cross-linked PMMA microbeads were compounded with the PLA through mixing in a counter-rotating twin screw extruder attached to a pelletizing die. The resin pellets were then was dried at 52° C. and fed by a plasticating screw extruder into an extrusion die manifold to produce a single layer melt stream (200° C.) which was rapidly quenched on a chill roll after issuing from the die. By regulating the throughput of the extruder, it was possible to adjust the thickness of the cast sheet to approximately 900 μm.

### Example 5 (Single Layer)

A single-layer polyester cast film is prepared in the following manner. The material used in the preparation was a compounded mix consisting of 38% by weight of PLA resin (NatureWorks 2002-D by Cargill-Dow) and 62% by weight of Barium Sulfate (Blanc Fixe Micro from Sachtleben) with a mean particle size of 0.8 μm.

The Barium Sulfate was compounded with the PLA through mixing in a counter-rotating twin screw extruder attached to a pelletizing die. The resin pellets were then was dried at 52° C. and fed by a plasticating screw extruder into an extrusion die manifold to produce a single layer melt stream (200° C.) which was rapidly quenched on a chill roll after issuing from the die. By regulating the throughput of the extruder, it was possible to adjust the thickness of the cast sheet to approximately 900 μm.

As many production scale Biaxially orienting film machines do not have co-extrusion capability the ability to manufacture a single layer open cell absorbent film is of great commercial utility. In order to determine the manufacturability of the single layer cast sheet samples above into voided open cell absorbent film the following evaluation was carried out. Each of the cast films was oriented or stretched in both the machine and transverse directions at a stretch ratio of 3.3. This was done utilizing a laboratory orienter capable of stretching in both directions simultaneously (Simul-Stretch). Samples of each film were stretched at varying temperatures. The lowest temperature at which the sample would stretch without tearing was first determined. The drytime was measured on the voided layer of the film to verify that it was less than 1 sec. Then more samples of each film were stretched at increasing temperatures. This was continued until a temperature at which the drytime became greater than 5 seconds was determined. The difference in temperature in degrees ° C. between the lowest stretch temperature and the highest stretch temperature that drytime remained below 5 seconds is called the process range. If there was no temperature that the sample could be stretched at to give a drytime less than 1 sec the process range is 0. Where the films had drytime below 5 seconds, the void volume of the voided layer was also determined by measuring before and after stretch thicknesses of the films. From this it was determined that the absorbent capacity of porous voided layers of each film was at least 14 cc/m². Table 2 shows the process range determined for all single layer samples.

TABLE 2

| | | | PROCESS | PROCESS |
|---|---|---|---|---|
| | | | RANGE | RANGE |
| SINGLE- | | MATRIX | SUMUL- | SEQUENTIAL- |
| LAYER | VOID | POLY- | STRETCH | STRETCH |
| SAMPLE | INITIATOR | MER | ° C. | ° C. |
| Comparative | PMMA | PETG | 0 | 0 |
| 4 | Beads | | | |
| Comparative | BaSO4 | PETG | 0 | 0 |
| 5 | | | | |
| Example 4 | PMMA | PLA | 3 | 2 |
| | Beads | | | |
| Example 5 | BaSO4 | PLA | 2 | 1 |

It can be seen in Table 2 that a single layer open cell absorbent film is not processable with either PMMA beads or BaSO4 when using PETG as the matrix polymer. However, a single layer open cell absorbent film is processable using either PMMA beads or BaSO4 when using PLA as the matrix polymer.

### Example 2

Preparation of Inkjet Recording Element with PLA Substrate

A microvoided PLA film, either a monoextruded or coextruded film as prepared above, can be used as a substrate or support for an optional porous ink-receiving layer. In particular, the ink-permeable PLA substrate can be coated at room temperature with Porous Composition 1, 2 or 3 below using a rod coater to give dry thickness of 4 aim. The coating should be allowed to air dry for 12 hours before inkjet printing.

Porous Composition 1

Water: 66 parts
Aerosil Mox 80® silica (Degussa Corporation): 8 parts
Nalco 2329® colloidal silica (Nalco Chemical Co.): 18 parts
N-(2-aminoethyl)-3-aminopropylmethyldimethoxysilane (United Chemicals Technologies, Inc.): 1 part
Styrene/butyl acrylate core shell latex: 6 parts
Kymene 557H® wet strength resin (Hercules Inc.): 1 part

The Aerosil Mox 80® silica was added to a 40% solution of Nalco 2329® colloidal silica with stirring over a one hour time period. N-(2-aminoethyl)-3-aminopropylmethyl-dimethoxysilane was added to this mixture and the mixture was sonicated for 12 hours. The styrene/butyl acrylate core shell latex, and Kymene 557H® wet strength resin were added to the resulting solution and stirred for 30 minutes.

Porous Composition 2

Syloid 620® silica (Grace Davison): 6.5 parts
Gohsenol GH-23® poly(vinyl alcohol) (The Nippon Synthetic Chemical Industry Co., Ltd.): 3.5 parts
Water: 90 parts

The Gohsenol GH-23® poly(vinyl alcohol) was added with stirring to water over a 20 minute time period. The mixture was then heated to 90° C. and stirred until a clear solution was obtained. This solution was cooled to room temperature and the Syloid 620® silica was added with stirring.

Porous Composition 3

GASIL HP39® silica gel (Crossfield Limited): 6.5 parts
Gohsenol GH-23® poly(vinyl alcohol): 3.5 parts
Water: 90 parts

Gohsenol GH-23® poly(vinyl alcohol) was slowly added with stirring to room temperature water over a 20 minute time period. The mixture was then heated to 90° C. and stirred until a clear solution was obtained. This solution was cooled to room temperature and the GASIL HP39® silica gel was added with stirring.

This invention has been described with particular reference to preferred embodiments thereof but it will be understood that modifications can be made within the spirit and scope of the invention.

1. An inkjet recording element comprising a permeable microvoided layer comprising a polylactic-acid-based material, in a continuous phase, and interconnecting voids.

2. The recording element of claim 1 wherein the microvoided layer has an ink absorbency rate resulting in a dry time of less than about 10 seconds.

3. The recording element of claim 1 wherein the microvoided layer has a total calculated absorbent capacity of at least about 14 cc/m².

4. The recording element of claim 1 wherein the voids contain void initiating particles.

5. The recording element of claim 4 wherein the particles having a particle size of from about 5 nm to about 15 μm.

6. The recording element of claim 1 wherein the microvoided layer is a biaxially oriented polylactic-acid-containing material.

7. The recording element of claim 1 wherein the microvoided layer has a dry thickness of from about 25 to about 400 μm.

8. The recording element of claim 1 wherein the polylactic-acid-based material is composed of at least 75% by weight of poly(L-lactic acid).

9. The recording element of claim 4 wherein the particles are inorganic and have an average particle size of from about 0.1 to about 10 μm and make up from about 45 to about 75 weight % of the total weight of the microvoided layer.

10. The recording element of claim 4 wherein the particles are organic and have an average particle size of from about 0.3 to about 2 μm and comprise from about 45 to about 75 weight % of the total weight of the microvoided layer.

11. The recording element of claim 1 wherein the polylactic-acid-based material comprises a mixture of at least 90% poly(L-lactic acid) and at least 1% poly(D-lactic acid).

12. The recording element of claim 9 wherein the inorganic particles are present in an amount between 50 to 65 weight %.

13. The recording element of claim 9 wherein the inorganic particles are selected from the group consisting of barium sulfate, calcium carbonate, zinc sulfide, zinc oxide, titanium dioxide, silica, alumina, and combinations thereof.

14. The recording element of claim 9 wherein said inorganic particles have an average size from 0.3 to 2.0 μm.

15. The recording element of claim 1 wherein the microvoided layer is an uppermost ink-receiving layer.

16. The recording element of claim 1 wherein the microvoided layer is a support or component thereof.

17. The recording element of claim 1 wherein the microvoided layer is between a support and an ink-receiving layer.

18. The recording element of claim 17 wherein the microvoided layer is in a multilayer support and is adjacent to a second support layer.

19. The recording element of claim 18 wherein the second support layer comprises a voided or non-voided polylactic-acid-based material which the second support layer is adjacent to and integral with the microvoided layer.

20. The recording element of claim 18 wherein the second support layer comprises paper or resin-coated paper.

21. The recording element of claim 1 wherein said continuous phase comprises additional polymers or blends of other polyesters.

22. An inkjet recording element comprising a porous image-receiving layer over a support, wherein the support and/or a substrate between the support and the image-receiving layer comprises a permeable microvoided layer comprising a polylactic-acid-based material, in a continuous phase, wherein both the image-receiving layer and the microvoided layer comprise interconnecting voids.

23. The recording element of claim 22 wherein the microvoided layer has an ink absorbency rate resulting in a dry time of less than about 10 seconds.

24. The recording element of claim 22 wherein the microvoided layer has a total calculated absorbent capacity of at least about 14 cc/m².

25. The recording element of claim 22 wherein the porous image-receiving layer having interconnecting voids comprises particles dispersed in a polymeric binder.

26. The recording element of claim 25 wherein the particles are inorganic.

27. The recording element of claim 26 wherein the inorganic particles comprise silica, alumina, zirconia, titania, calcium carbonate or barium sulfate.

28. The recording element of claim 25 wherein the particles are organic.

29. The recording element of claim 25 wherein the polymeric binder comprises a hydrophilic binder.

30. The recording element of claim 29 wherein the hydrophilic binder comprises poly(vinyl alcohol), poly(vinyl acetate), poly(vinyl pyrrolidone), gelatin, poly(2-ethyl-2-oxazoline), poly(2-methyl-2-oxazoline), poly( acrylamide), chitosan, poly(ethylene oxide), methyl cellulose, ethyl cellulose, hydroxyethyl cellulose, or hydroxypropyl cellulose.

31. The recording element of claim 25 wherein said polymeric binder comprises a hydrophobic binder.

32. The recording element of claim 31 wherein said hydrophobic binder comprises poly(styrene-co-butadiene), a polyurethane latex, a polyester latex, poly(n-butyl acrylate), poly(n-butyl methacrylate), poly(2-ethylhexyl acrylate), a copolymer of n-butylacrylate and ethylacrylate or a copolymer of vinylacetate and n-butylacrylate.

33. The recording element of claim 25 wherein the volume ratio of the particles to said binder is from about 1:1 to about 15:1.

34. The recording element of claim 22 wherein the support further comprises paper laminated to a side of the microvoided layer which does not have thereon said image-receiving layer.

35. An inkjet recording element comprising a porous image-receiving layer over a monolayer support, the monolayer comprising a permeable microvoided layer in which a continuous phase comprises a polylactic-acid-based material having interconnecting voids.

36. An inkjet printing process, comprising the steps of:
A) providing an inkjet printer that is responsive to digital data signals;
B) loading the printer with an inkjet recording element as described in claim 1;
C) loading the printer with an inkjet ink composition; and
D) printing on the inkjet recording element using the inkjet ink in response to the digital data signals.

37. The inkjet printing process of claim 36 wherein the permeable microvoided layer was extruded as a monolayer film.

38. The inkjet printing process of claim 36 wherein the permeable microvoided layer was stretched at a temperature of under 75° C.
